(19) United States
(12) Patent Application Publication
(10) Pub. No.: US 2007/0084280 A1
(43) Pub. Date: Apr. 19, 2007

(54) Semi-constant temperature excitation method for fluid flow sensors

(76) Inventors: Rajinder S. Gill, Austin, TX (US); Jarrid M. Gross, Fullerton, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/508,706

(22) Filed: Aug. 23, 2006

Related U.S. Application Data
(60) Provisional application No. 60/711,728, filed on Aug. 26, 2005.

(51) Int. Cl. G01F 1/68

(52) U.S. Cl. 73/204.27

(57) ABSTRACT

Excitation power to fluid flow measurement sensor is applied in such a way so as to maintain some part of the sensor elements at a constant temperature relative to the ambient fluid temperature and some part of the sensor elements to change its temperature with fluid flow which results in a sensor output that remains constant and linear with per unit flow. This semi-constant temperature sensor excitation scheme results in higher sensor output, added sensor range and temperature insensitive flow measurement. Therefore, this sensor excitation method negates the drawbacks of smaller and non-linear output and/or thermal runaway that are associated with other excitation methods.

### RELATED APPLICATION

The present application is based on and claims priority to U.S. Provisional application Ser. No. 60/711,728, filed Aug. 26, 2005 and bearing Attorney Docket No. M-16145-V1US.

### BACKGROUND

1. Field of the Invention

The present invention relates generally to fluid flow measurement sensors, and more particularly to methods and circuits that enable linear and constant sensor outputs.

2. Related Art

In a fluid flow measurement device such as a mass flow controller, a sensor 100 typically has multiple coils 102 and 104 wrapped around a sensor tube 106 as shown in FIG. 1. The sensor is usually excited either by a constant power, current, or voltage source. When fluid flows inside sensor tube 106 from a heated upstream coil 102 to a heated downstream coil 104 that are electrically balanced, thermal energy is transferred from the coils to the flowing fluid. For a given flow rate, the amount of thermal energy transferred from the coils to the fluid is inversely proportional to the fluid temperature. Thermal energy transfer from the upstream coil 102 and the downstream coil 104 is disproportionate because the fluid temperature is different at the upstream coil than at the downstream coil. This different rate of heat transfer from the coils to the fluid causes temperature differential between the coils which manifests itself as a change in relative resistance of the two coils. This change in resistance is directly proportional to the amount of fluid flowing through the sensor tube.

The upstream and downstream sensor coils are part of a Wheatstone bridge. The circuit is configured to form a balanced bridge network with little or zero output when there is no fluid flow. The bridge network measures the flow through the sensor as a change of resistance of the coils and generates a signal corresponding to the flow rate of the fluid through the sensor tube. The problems associated with the above sensor excitation schemes are non-linear output, thermal runaway and low sensor output.

Accordingly, there is a need in the art for a fluid flow measurement sensor that gives a high linear sensor output without the danger of thermal runaway.

### SUMMARY

According to one aspect of the present invention, a semi-constant temperature excitation method for fluid flow measurement sensor involves maintaining some part of the sensor elements (e.g., an upstream coil, or a downstream coil, or a portion of each coil) at a constant temperature relative to the ambient fluid temperature and some part of the sensor elements to change their temperature with fluid flow so that the sensor output remains constant and linear per flow unit. This scheme can drive the upstream coil at a constant temperature T_{Ru} relative to ambient or drive the downstream coil at a constant temperature T_{Rd} relative to ambient.

Additionally, the sensor could be driven so that upstream and downstream coils are allowed to change their temperatures T_{Ru} and T_{Rd}, respectively, at a certain proportional rate relative to a temperature between T_{Ru} and T_{Rd} which is maintained constant above the ambient.

This sensor excitation scheme of maintaining a part of the sensor elements at a constant temperature relative to ambient has certain definite advantages as compared to conventional excitation methods.

For example, in a conventional constant current drive method, the sensor output per unit flow drops as the flow increases due to uncompensated cooling of the sensor elements. In a conventional constant voltage drive method, the sensor output per unit flow increases as the flow increases due to uncompensated heating of the sensor elements. The resultant condition can lead to a thermal run-away, and subsequent sensor damage. Both drive methods result in sensor non-linearity, which degrades progressively at higher and higher flows. This requires the sensor full scale flow range to be selected at a low flow value in order to maximize output linearity.

The semi-constant temperature excitation method allows a higher sensor output, higher sensor full scale flow range (since the sensor can be forced to flow more fluid without losing linearity), and inherent temperature insensitive flow measurement without the problems of low, non-linear output or thermal runaway.

These and other features and advantages of the present invention will be more readily apparent from the detailed description of the preferred embodiments set forth below taken in conjunction with the accompanying drawings.

### BRIEF DESCRIPTION OF THE FIGURES

FIG. 1 shows a conventional mass flow sensor;

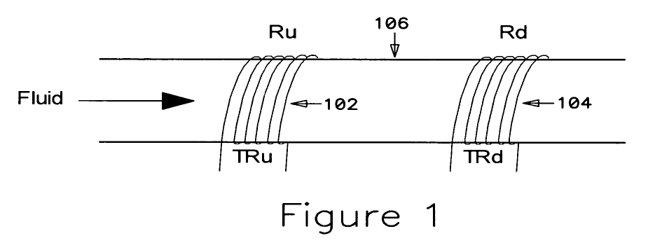

FIG. 2 shows a half bridge circuit, according to one embodiment, with constant average temperature ((T_{Ru}+T_{Rd})/2) of upstream and downstream sensor coils with respect to ambient temperature;

FIG. 3 shows a half bridge circuit, according to another embodiment, with constant temperature (T_{Ru}) of upstream sensor coil with respect to ambient temperature;

FIG. 4 shows a full bridge circuit, according to one embodiment, with constant temperature (T_{(f(Ru)+f(Rd))}) with respect to ambient temperature that is adjustable between T_{Ru} and T_{Rd} of sensor coils;

FIG. 5 shows a full bridge circuit, according to another embodiment, with constant temperature (T_{Ru}) of upstream sensor coil with respect to ambient and with slave mirror current in downstream sensor coil;

FIG. 6 shows a full bridge circuit, according to yet another embodiment, with constant temperature (T_{Ru}) of upstream sensor coil with respect to ambient and with slave mirror voltage across downstream sensor coil; and

FIG. 7 shows the fluid flow versus output of a sensor using different sensor excitation methods.

Like element numbers in different figures represent the same or similar elements.

### DETAILED DESCRIPTION

According to one aspect of the present invention, a part of the sensor elements, which could be the upstream element with resistance Rᵤ, the downstream element with resistance R_{d}, or a combination of a certain proportion of Rᵤ and R_{d} (i.e., X % of Rᵤ+Y % of R_{d}), is kept at a constant temperature differential with respect to the ambient temperature of the fluid. This condition is maintained under all fluid flow conditions. Ambient temperature of the fluid, before it enters the sensor, is measured by R_{ref} or it could be measured separately from the sensor electrical circuit and the correction applied by microprocessor firmware. The rest of the sensor is allowed to change its temperature with fluid flow.

A variable voltage source electrical circuit with feedback is used to excite all the elements of the sensor as well as to measure the fluid ambient temperature and keep a part of the sensor elements at a constant temperature differential with respect to the ambient temperature of the fluid.

Upstream and downstream sensor elements with resistance Rᵤ and R_{d}, respectively, and the ambient temperature measurement element with resistance R_{ref} comprise of the same material with a large temperature coefficient of resistance. The ambient resistances Rᵤ and R_{d} of the elements are made approximately equal.

The variable voltage source electrical circuit with feedback is configured in such a way so that with no fluid flow, the voltage drop across the upstream element and downstream element is approximately equal. Therefore, an approximately equal amount of electrical power is dissipated from the upstream and the downstream elements with no fluid flow, resulting in temperature T_{Ru} and T_{Rd} being approximately equal.

When a fluid flows through the sensor past the upstream element, heat energy is lost from the upstream element in proportion to the temperature difference of the element to the fluid temperature (T_{Ru}−T_{Rref}) and the rate of mass flow of the fluid. The fluid temperature increases by a small amount (ΔT) and becomes T_{Rref}+ΔT.

As the fluid passes the downstream element, heat energy is lost from the downstream element in proportion to the temperature difference of the element to the fluid temperature (T_{Rd}−T_{Rref}−ΔT) and the rate of mass flow of the fluid.

The mass flow rate of the fluid is same across the upstream and the downstream elements. However, the heat loss from the upstream element is more than the heat loss from the downstream element, because the temperature differential between the element and the fluid is greater at the upstream element than at the downstream element.

This different rate of heat loss from the upstream and downstream elements manifests itself by changing the resistance of the elements in proportion to the amount of heat loss. However, the variable voltage source electrical circuit with feedback tries to maintain a part of the sensor elements at a constant temperature differential with respect to the ambient temperature of the fluid. Depending upon the electrical circuit configuration, the part of the sensor elements kept at a constant temperature differential with respect to the ambient temperature of the fluid could be the upstream element with resistance Rᵤ, the downstream element with resistance R_{d}, or a combination of a certain proportion of Rᵤ and R_{d} (X % of Rᵤ+Y % of R_{d}). This causes the voltage across Rᵤ and R_{d} to change in proportion to the mass flow rate of the fluid. This voltage differential across Rᵤ and R_{d} is directly proportional to the mass flow rate of the fluid.

The variable voltage source electrical circuit also provides soft start of the sensor. At the instance when excitation power is applied, the sensor elements are at ambient temperature and the circuit is essentially operating in an open loop control mode. Without a soft start, a high current surge through the elements could destroy the sensor elements. The circuit also monitors the voltage difference across the sensor elements and limits the current through the elements if an uncontrolled fluid flow surge through the sensor occurs. Without current limiting, the sensor could get into thermal run-away mode resulting in sensor destruction.

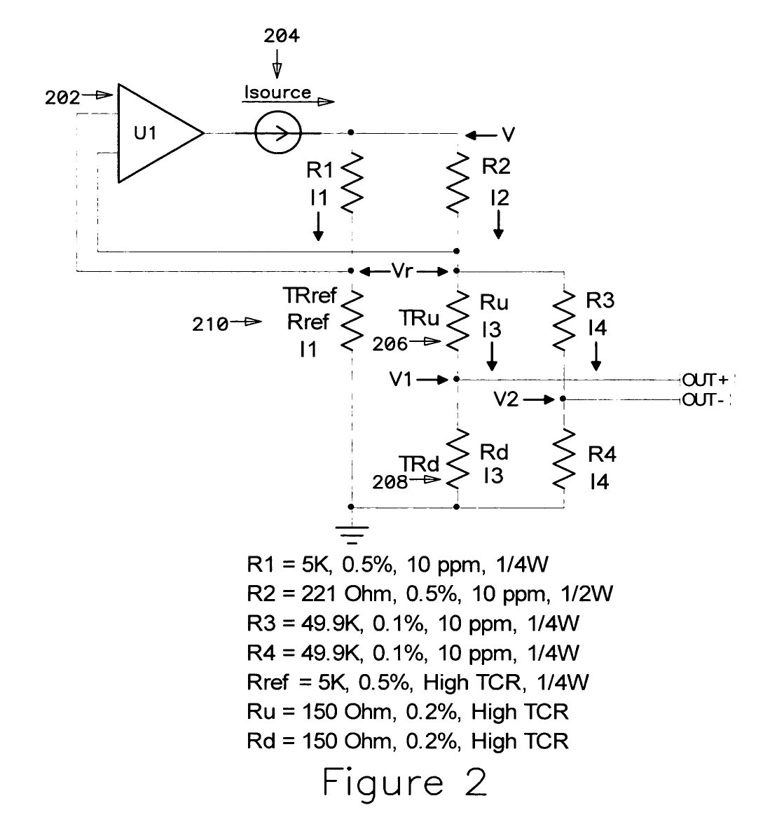

FIGS. 2-6 show various circuit configurations for implementing the above-described invention. FIG. 2 shows a half-bridge circuit 200 according to one embodiment of the present invention. Circuit 200 includes an amplifier 202 and a current source 204. The upstream and downstream sensor coils 206 and 208 are made in such a way so that their respective resistances Rᵤ (for the upstream element) and R_{d} (for the downstream element) are approximately equal at ambient temperature. Values of Rᵤ and R_{d} are selected based on the desired temperature difference of the sensor coils relative to ambient temperature T_{Rref} as measured by R_{ref} and the maximum available voltage from the variable voltage source electrical circuit. The upstream and downstream sensor elements may also be planar heating elements, such as made by thin/thick film deposition.

The value for R_{ref} is selected so that during normal operation, its power dissipation does not affect its resistance due to self-heating. The actual component 210 associated with R_{ref} is thermally connected to a large thermal mass, which indicates the pre-sensor fluid temperature. R_{ref}, Rᵤ, and R_{d} all comprise of the same type of material in one embodiment, thus ensuring that their temperature coefficients of resistance are equal.

R₁ has a low temperature coefficient of resistance and its ohmic value is selected to set the temperature ratio between (Rᵤ+R_{d}) and R_{ref}. R₂ is selected with a low temperature coefficient of resistance and an ohmic value near that of Rᵤ or R_{d} resistance.

Resistor R₃ and resistor R₄ form a passive bridge circuit to enable differential sensor output. R₃ and R₄ resistances have a low temperature coefficient of resistance and their ohmic values are sufficiently high to minimize thermal loading and subsequent temperature control error of the Rᵤ and R_{d} pair.

The ratio R₁/R_{ref} sets a reference voltage (Vᵣ) on U₁, which in turn forces the sum of upstream resistor Rᵤ and downstream resistor R_{d} to increase resistance due to thermal heating, until the ratios of R₁/R_{ref} and R₂/(Rᵤ+R_{d}) are approximately equal. When this is achieved, the resistance (Rᵤ+R_{d}), and therefore the average temperature (T_{Ru}+T_{Rd})/2, will track the resistance R_{ref} and its temperature T_{Rref}. Since the average temperature (T_{Ru}+T_{Rd})/2 is maintained constant above the ambient and the same amount of current flows through R_{d} as through Rᵤ, the resistances Rᵤ and R_{d} will be nearly identical with no fluid flow. As fluid flow increases, more heat energy is lost from the upstream element than from the downstream element and therefore T_{Ru} and Rᵤ decrease more than T_{Rd} and R_{d}, thus causing the voltage across Rᵤ to decrease and the voltage across R_{d} to increase. The excitation circuit will automatically compensate for the required heat energy increase in order to maintain a constant temperature average (T_{Ru}+T_{Rd})/2 above ambient. The attached Appendix shows details the various voltages and output ΔV of circuit 200. FIG. 2 also shows exemplary resistor values according to one embodiment.

The current source I_{source} is normally not a part of the sensor excitation power control loop, but does limit the power to the excitation circuit when the excitation circuit is open loop (e.g. at startup and during massive fluid overflow conditions).

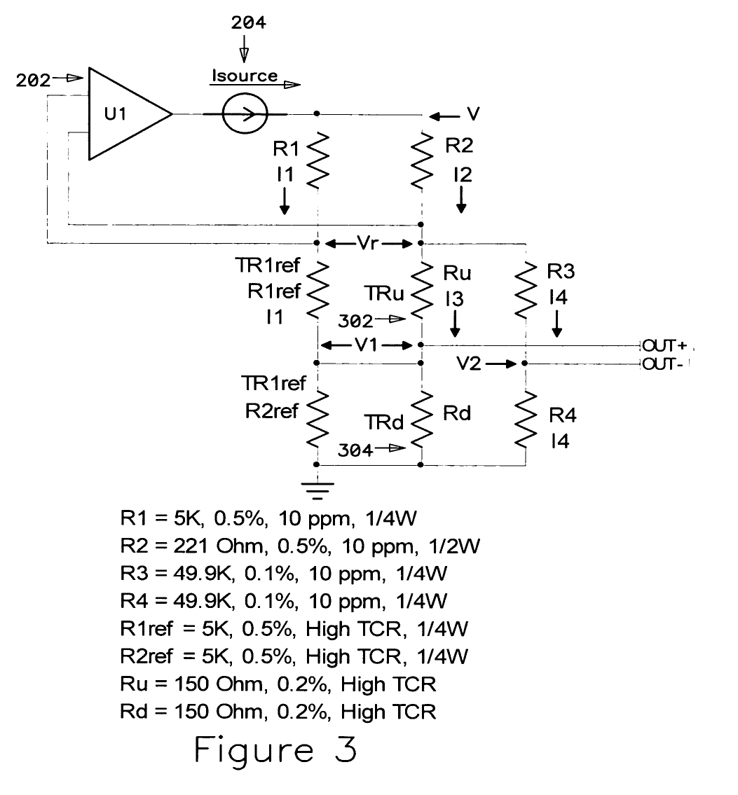

FIG. 3 shows a half bridge circuit 300 another embodiment of the present invention. Circuit 300 includes an amplifier 202 and a current source 204. The upstream and downstream sensor coils 302 and 304 are made in such a way so that their respective resistances Rᵤ and R_{d} are approximately equal at ambient temperature. Values of Rᵤ and R_{d} are selected based on the desired temperature difference of the sensor coils relative to ambient temperature T_{R1ref} as measured by R_{1ref} and the maximum available voltage from the variable voltage source electrical circuit.

R_{1ref} and R_{2ref} values are nearly equal in magnitude and selected so that during normal operation, their power dissipation does not affect their respective resistances due to self-heating. The actual components associated with R_{1ref} and R_{2ref} are thermally connected to a large thermal mass, which indicates the pre-sensor fluid temperature. R_{1ref}, R_{2ref}, Rᵤ, and R_{d} all comprise of the same type of material in one embodiment, thus ensuring that their temperature coefficients of resistance are equal.

R₁ has a low temperature coefficient of resistance and its ohmic value is selected to set the temperature ratio between Rᵤ and R_{1ref}. R₂ is selected with a low temperature coefficient of resistance and an ohmic value near that of Rᵤ or R_{d} resistance.

Resistor R₃ and resistor R₄ form a passive bridge circuit to enable differential sensor output. R₃ and R₄ resistances have a low temperature coefficient of resistance and their ohmic values are sufficiently high to minimize thermal loading and subsequent temperature control error of the Rᵤ and R_{d} pair.

The ratio of resistor R₁ to resistor R_{1ref} sets a reference voltage (Vᵣ) on U₁, which in turn forces the sum of upstream resistor Rᵤ and downstream resistor R_{d} to increase resistance due to thermal heating, until the ratios R₁/R_{1ref} and R₂/Rᵤ are approximately equal. When this is achieved, the resistance Rᵤ, and therefore its temperature T_{Ru}, will track the resistance R_{1ref} and its temperature T_{R1ref}. Since the temperature T_{Ru} is maintained constant above the ambient and same amount of current flows through R_{d} as through Rᵤ, the resistances Rᵤ and R_{d} will be nearly identical with no fluid flow. As fluid flow increases, more heat energy is lost from upstream element than from downstream element and therefore T_{Ru} and Rᵤ decrease more than T_{Rd} and R_{d}, thus causing the voltage across Rᵤ to decrease more than the voltage across R_{d}. The excitation circuit will automatically compensate for the required heat energy increase in order to maintain the constant temperature T_{Ru} above ambient. R_{2ref} does not significantly affect the Rᵤ temperature, but is included to provide an equivalent load across R_{d} to compensate the equivalent Thevenin loading between R_{1ref} and Rᵤ. The attached Appendix shows details the various voltages and output ΔV of circuit 300. FIG. 3 also shows exemplary resistor values according to one embodiment

The current source I_{source} is normally not a part of the sensor excitation power control loop, but does limit the power to the excitation circuit when the excitation circuit is open loop (e.g. at startup and during massive fluid overflow conditions).

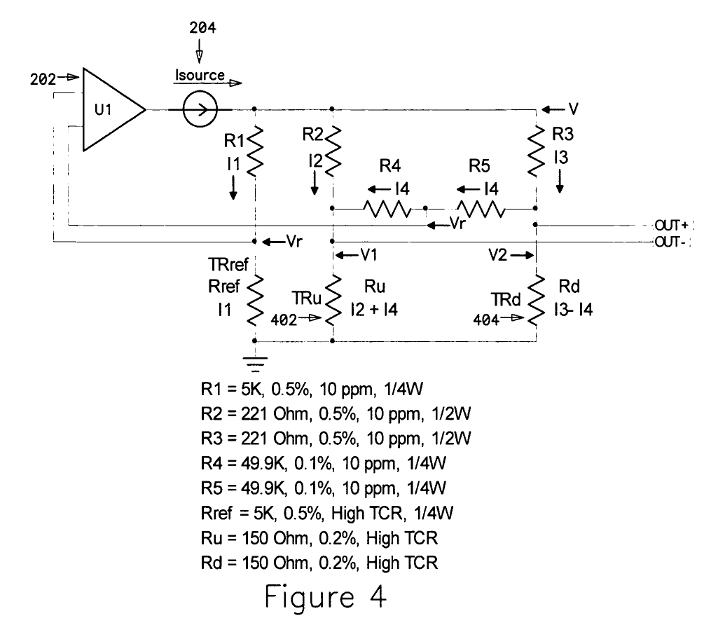

FIG. 4 shows a full bridge circuit 400 according to another embodiment of the present invention. Circuit 400 includes an amplifier 202 and a current source 204. The upstream and downstream sensor coils 402 and 404 are made in such a way so that their respective resistances Rᵤ and R_{d} are approximately equal at ambient temperature. Values of Rᵤ and R_{d} are selected based on the desired temperature difference of the sensor coils relative to ambient temperature T_{Rref} as measured by R_{ref} and the maximum available voltage from the variable voltage source electrical circuit.

R_{ref} value is selected so that during normal operation, its power dissipation does not affect its resistance due to self-heating. The actual component associated with R_{ref} is thermally connected to a large thermal mass, which indicates the pre-sensor fluid temperature. R_{ref}, Rᵤ, and R_{d} are all made of the same type of material, thus ensuring that their temperature coefficients of resistance are equal.

R₁ has a low temperature coefficient of resistance and its ohmic value is selected to set the temperature ratio between the resistance of the Rᵤ and R_{d} network and R_{ref}. R₂ and R₃ are selected with a low temperature coefficient of resistance and an ohmic value near that of Rᵤ or R_{d} resistance. R₄ and R₅ have a low temperature coefficient of resistance and their ohmic values are selected so that during normal operation, their power dissipation does not affect their respective resistance due to self-heating.

The ratio R₁/R_{ref} sets a reference voltage (Vᵣ) on U₁, which in turn forces the sum of upstream resistor Rᵤ and downstream resistor R_{d} to increase resistance due to thermal heating, until the voltage at the node of R₁ and R_{ref} is equal to the voltage at the node of R₄ and R₅. When this is achieved, the resistance of network Rᵤ and R_{d} and its average temperature T_{(f(Ru)+f(Rd))} will track the resistance R_{ref} and its corresponding temperature T_{Rref}. Since the average temperature of Rᵤ and R_{d} network is maintained constant above the ambient and if R₄ and R₅ are equal in magnitude, then the resistances Rᵤ and R_{d} will be nearly identical with no flow. As fluid flow increases, more heat energy is lost from upstream element than from downstream element. Therefore T_{Ru} and Rᵤ decrease more than T_{Rd} and R_{d} causing the voltage across Rᵤ to decrease and the voltage across R_{d} to increase. The excitation circuit will automatically compensate for the required heat energy increase in order to maintain the average temperature T_{(f(Ru)+f(Rd))} of the Rᵤ and R_{d} network above ambient constant. When R₄ and R₅ are equal, this circuit operates in a similar manner as a half bridge circuit with constant average temperature ((T_{Ru}+T_{Rd})/2) above ambient of upstream and downstream sensor coils as shown in FIG. 2.

This full bridge circuit allows the temperature control from 100% of constant temperature above ambient of the upstream element to 100% of constant temperature above ambient of the downstream element, or any ratio in between by varying R₄ and R₅.

This circuit uses slightly more power than the circuit in FIG. 2 due to R₃ dissipation, but the full bridge output provides nearly 100% more differential voltage output, which improves the signal to noise and signal to error ratios accordingly. Another benefit of running the full bridge topology is the reduction of the total power supply voltage requirement, since Rᵤ and R_{d} elements are in parallel instead of in series. The attached Appendix shows details the various voltages and output ΔV of circuit 400. FIG. 4 also shows exemplary resistor values according to one embodiment

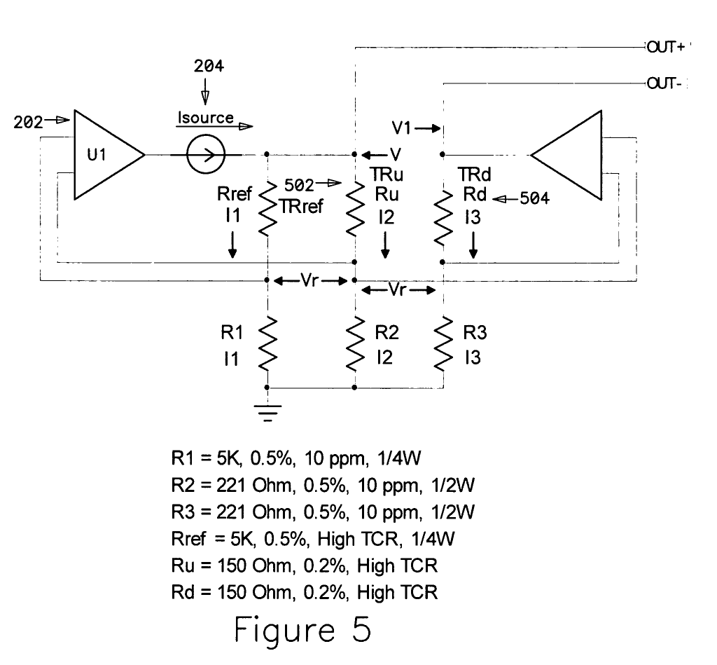

FIG. 5 shows a full bridge circuit 500 according another embodiment of the present invention. Circuit 500 includes an amplifier 202 and a current source 204. The upstream and downstream sensor coils 502 and 504 are made in such a way so that their respective resistances Rᵤ and R_{d} are approximately equal at ambient temperature. Values of Rᵤ and R_{d} are selected based on the desired temperature difference of the sensor coils relative to ambient temperature T_{Rref} as measured by R_{ref} and the maximum available voltage from the variable voltage source electrical circuit.

The value of R_{ref} is selected so that during normal operation, its power dissipation does not affect its resistance due to self-heating. The actual component associated with R_{ref} is thermally connected to a large thermal mass, which indicates the pre-sensor fluid temperature. R_{ref}, Rᵤ, and R_{d} all comprise of the same type of material in one embodiment, thus ensuring that their temperature coefficients of resistance are equal.

R₁ has a low temperature coefficient of resistance and its ohmic value is selected to set the temperature ratio between Rᵤ and R_{ref}. R₂ and R₃ are selected with a low temperature coefficient of resistance and an ohmic value near that of Rᵤ or R_{d} resistance.

The ratio R₁/R_{ref} sets a reference voltage (Vᵣ) on U₁, which in turn forces the upstream resistor Rᵤ to increase resistance due to thermal heating, until the ratios of R_{ref}/R₁ and Rᵤ/R₂ are approximately equal. When this is achieved, the resistance Rᵤ and therefore its temperature T_{Ru} will track the resistance R_{ref} and its temperature T_{Rref}. Since the temperature T_{Ru} is maintained constant and element R_{d} is driven by a current mirror with a value equal to that of the current flowing through Rᵤ, the resistances Rᵤ and R_{d} will be nearly identical with no flow. As flow increases, more heat energy is lost from Rᵤ than from R_{d}. Therefore the current through Rᵤ must be increased in order to maintain a constant T_{Ru} above ambient. The excitation circuit will automatically compensate for the required heat energy increase in order to maintain the constant temperature T_{Ru} above ambient, thus resulting in voltage increase across Rᵤ. Since the same current is flowing through R_{d} and heat loss from R_{d} is less as compared to Rᵤ, the voltage increase across R_{d} will be higher than across Rᵤ.

This circuit uses slightly higher power than the half bridge equivalent circuit (due to R₃ dissipation) as shown in FIG. 3, but the full bridge output provides nearly 100% more differential voltage output, which improves the signal to noise and signal to error ratios accordingly. Another benefit of running the full bridge topology is the reduction of the total power supply voltage requirement, since the Rᵤ and R_{d} elements are in parallel instead of in series. The attached Appendix shows details the various voltages and output ΔV of circuit 500. FIG. 5 also shows exemplary resistor values according to one embodiment

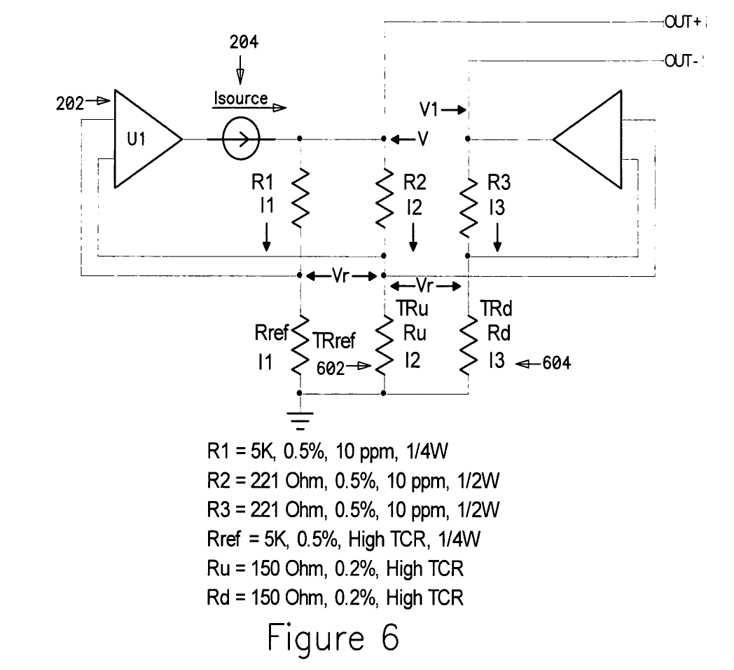

FIG. 6 shows a full bridge circuit 600 according another embodiment of the present invention. Circuit 600 includes an amplifier 202 and a current source 204. The upstream and downstream sensor coils 602 and 604 are made in such a way so that their respective resistances Rᵤ and R_{d} are approximately equal at ambient temperature Values of Rᵤ and R_{d} are selected based on the desired temperature difference of the sensor coils relative to ambient temperature T_{Rref} as measured by R_{ref} and the maximum available voltage from the variable voltage source electrical circuit.

The value of R_{ref} is selected so that during normal operation, its power dissipation does not affect its resistance due to self-heating. The actual component associated with R_{ref} is thermally connected to a large thermal mass, which indicates the pre-sensor fluid temperature. R_{ref}, Rᵤ, and R_{d} are all made of the same type of material, thus ensuring that their temperature coefficients of resistance are equal.

R₁ has a low temperature coefficient of resistance and its ohmic value is selected to set the temperature ratio between Rᵤ and R_{ref}. R₂ and R₃ are selected with a low temperature coefficient of resistance and an ohmic value near that of Rᵤ or R_{d} resistance.

The ratio R₁/R_{ref} sets a reference voltage (Vᵣ) on U₁, which in turn forces the upstream resistor Rᵤ to increase resistance due to thermal heating, until the ratios R₁/R_{ref} and R₂/Rᵤ are approximately equal. When this is achieved, the resistance Rᵤ and therefore its temperature T_{Ru} will track the resistance R_{ref} and its temperature T_{Rref}. Since the temperature T_{Ru} is maintained constant and element R_{d} is driven by a voltage mirror with a value equal to that of the voltage across Rᵤ, the resistances Rᵤ and R_{d} will be nearly identical with no flow. As flow increases, more heat energy is lost from Rᵤ than from R_{d}. Therefore, the current through Rᵤ must be increased in order to maintain a constant T_{Ru} above ambient. The excitation circuit will automatically compensate for the required heat energy increase in order to maintain the constant temperature T_{Ru} above ambient, thus resulting in voltage increase across Rᵤ. Since the same voltage is maintained across R_{d} and heat loss from R_{d} is less as compared to Rᵤ, the current through R_{d} will be less than current through Rᵤ.

This circuit uses slightly higher power than the half bridge equivalent circuit (due to R₃ dissipation) as shown in FIG. 3, but the full bridge output provides nearly 100% more differential voltage output, which improves the signal to noise and signal to error ratios accordingly. Another benefit of running the full bridge topology is the reduction of the total power supply voltage requirement, since Rᵤ and R_{d} elements are in parallel instead of in series. The attached Appendix shows details the various voltages and output ΔV of circuit 600. FIG. 6 also shows exemplary resistor values according to one embodiment

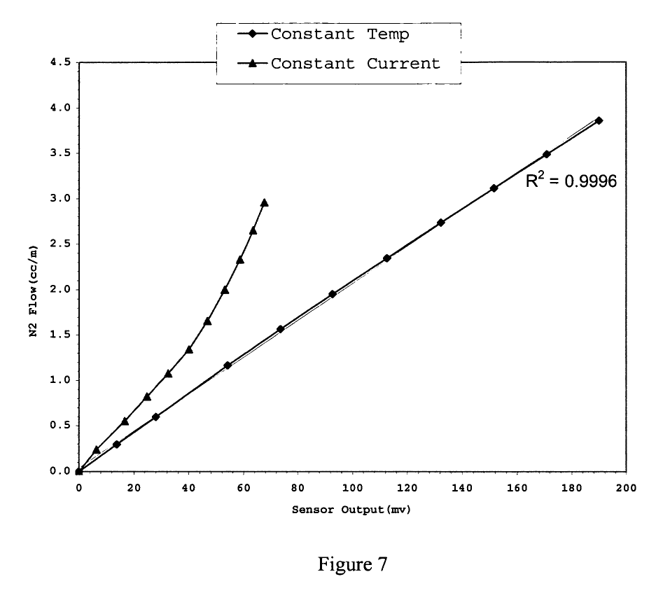

FIG. 7 shows the relative performance of a conventional constant current excitation method to one embodiment of the semi-constant temperature excitation method used in a thermal fluid flow sensor of a mass flow controller.

The sensor excited with one embodiment of the present invention exhibits near perfect linearity as a function of mass flow as well as higher sensor output per flow unit as compared to the sensor excited by constant current method.

This excitation scheme lends itself well to multi-range or wide range usage. The high sensor output means that the signal to error ratio is superior to other excitation methods.

The sensor design lends itself well to thermal balance between the upstream and down stream coils. Therefore, the sensor position has very little effect on the output.

Having thus described embodiments of the present invention, persons of ordinary skill in the art will recognize that changes may be made in form and detail without departing from the scope of the invention. Thus the invention is limited only by the following claims.

### APPENDIX

FIG. 2:
V=I₁×(R₁+R_{REF}) (1)
V_{R}=I₁×R_{REF} (2)
Dividing Eq. (1) by Eq. (2):

$$\begin{matrix}\frac{V}{{V}_{R}} = \frac{( {R}_{1} + {R}_{REF} )}{{R}_{REF}} = \frac{{R}_{1}}{{R}_{REF}} + 1 & \\ \frac{{R}_{1}}{{R}_{REF}} = \frac{( V - {V}_{R} )}{{V}_{R}} & ( 3 ) \\ V = {I}_{2} \times [ {R}_{2} + \frac{( {R}_{U} + {R}_{D} ) ( {R}_{3} + {R}_{4} )}{( {R}_{3} + {R}_{4} + {R}_{U} + {R}_{D} )} ] & ( 4 ) \\ {V}_{R} = {I}_{2} \times \frac{( {R}_{U} + {R}_{D} ) ( {R}_{3} + {R}_{4} )}{( {R}_{3} + {R}_{4} + {R}_{U} + {R}_{D} )} & ( 5 )\end{matrix}$$

From Eq. (3), (4) and (5):

$$\begin{matrix}\begin{matrix}\frac{{R}_{1}}{{R}_{REF}} = \frac{[ {I}_{2} \times ( {R}_{2} + \frac{( {R}_{U} + {R}_{D} ) ( {R}_{3} + {R}_{4} )}{( {R}_{3} + {R}_{4} + {R}_{U} + {R}_{D} )} ) - {I}_{2} \times \frac{( {R}_{U} + {R}_{D} ) ( {R}_{3} + {R}_{4} )}{( {R}_{3} + {R}_{4} + {R}_{U} + {R}_{D} )} ]}{{I}_{2} \times \frac{( {R}_{U} + {R}_{D} ) ( {R}_{3} + {R}_{4} )}{( {R}_{3} + {R}_{4} + {R}_{U} + {R}_{D} )}} \\ = \frac{{R}_{2} \times ( {R}_{3} + {R}_{4} + {R}_{U} + {R}_{D} )}{( {R}_{U} + {R}_{D} ) ( {R}_{3} + {R}_{4} )} \\ = \frac{{R}_{2}}{( {R}_{U} + {R}_{D} )} \times \frac{( {R}_{3} + {R}_{4} + {R}_{U} + {R}_{D} )}{( {R}_{3} + {R}_{4} )}\end{matrix} \\ If {R}_{3} , {R}_{4} ⪢ {R}_{U} , {R}_{D} , then & ( 6 ) \\ \frac{{R}_{1}}{{R}_{REF}} ≅ \frac{{R}_{2}}{( {R}_{U} + {R}_{D} )} = K ( Constant ) & ( 7 ) \\ {V}_{R} = {I}_{3} \times ( {R}_{U} + {R}_{D} ) & ( 8 ) \\ {V}_{R} = {I}_{4} \times ( {R}_{3} + {R}_{4} ) & ( 9 )\end{matrix}$$

From Eq. (8) and (9):

$$\begin{matrix}{I}_{3} \times ( {R}_{U} + {R}_{D} ) = {I}_{4} \times ( {R}_{3} + {R}_{4} ) & \\ \frac{{I}_{3}}{{I}_{4}} = \frac{( {R}_{3} + {R}_{4} )}{( {R}_{U} + {R}_{D} )} & ( 10 ) \\ {V}_{1} = {I}_{3} \times {R}_{D} & ( 11 ) \\ {V}_{2} = {I}_{4} \times {R}_{4} & ( 12 )\end{matrix}$$

Subtracting Eq.(12) from Eq. (11):

$${V}_{1} - {V}_{2} = {I}_{3} \times {R}_{D} - {I}_{4} \times {R}_{4} = {I}_{4} ( \frac{{I}_{3} \times {R}_{D}}{{I}_{4}} - {R}_{4} ) \qquad ( 13 )$$

From Eq. (9), (10) and (13):

$$\begin{matrix}Δ V = \frac{{V}_{R}}{( {R}_{3} + {R}_{4} )} [ {R}_{D} \frac{( {R}_{3} + {R}_{4} )}{( {R}_{U} + {R}_{D} )} - {R}_{4} ] & \\ Δ V = \frac{{V}_{R}}{( {R}_{3} + {R}_{4} )} [ \frac{{R}_{D} \times {R}_{3} + {R}_{D} \times {R}_{4} - {R}_{4} \times {R}_{U} - {R}_{4} \times {R}_{D}}{{R}_{U} + {R}_{D}} ] \\ If {R}_{3} = {R}_{4} , then Eq . ( 14 ) becomes & ( 14 ) \\ Δ V = \frac{{V}_{R}}{2} [ \frac{{R}_{D} - {R}_{U}}{{R}_{U} + {R}_{D}} ] & ( 15 )\end{matrix}$$

FIG. 3:
V−V_{R}=I₁×R₁ (1)
V_{R}−V₁=I₁×R_{1REF} (2)
Dividing Eq (1) by Eq. (2):

$$\begin{matrix}\frac{( V - {V}_{R} )}{{V}_{R} - {V}_{1}} = \frac{{R}_{1}}{{R}_{1 REF}} & ( 3 ) \\ V - {V}_{R} = {I}_{2} \times {R}_{2} & ( 4 ) \\ {V}_{R} - {V}_{1} = {I}_{3} \times {R}_{U} & ( 5 )\end{matrix}$$

From Eq. (3), (4), and (5):

$$\begin{matrix}\frac{{R}_{1}}{{R}_{1 REF}} = \frac{( V - {V}_{R} )}{( {V}_{R} - {V}_{1} )} = \frac{( {I}_{2} \times {R}_{2} )}{( {I}_{3} \times {R}_{U} )} & ( 6 ) \\ {I}_{2} = {I}_{3} + {I}_{4} & ( 7 )\end{matrix}$$

Since R₃ and R₄>>R_{U} and R_{D}, L₄≈0 and Eq (7) becomes
I₂=I₃ (8)
From Eq (6) and (8):

$$\begin{matrix}\frac{{R}_{1}}{{R}_{1 REF}} = \frac{{R}_{2}}{{R}_{U}} = K ( Constant ) \\ {V}_{R} = {I}_{4} \times ( {R}_{3} + {R}_{4} ) & ( 9 ) \\ {I}_{4} = \frac{{V}_{R}}{( {R}_{3} + {R}_{4} )} & ( 10 ) \\ {V}_{2} = {I}_{4} \times {R}_{4} & ( 11 )\end{matrix}$$

From Eq. (10) and (11):

$$\begin{matrix}{V}_{2} = \frac{{V}_{R} \times {R}_{4}}{( {R}_{3} + {R}_{4} )} & ( 12 ) \\ {V}_{1} = \frac{( {I}_{1} + {I}_{3} ) \times {R}_{D} \times {R}_{2 REF}}{( {R}_{D} + {R}_{2 REF} )} & ( 13 ) \\ {V}_{R} - {V}_{1} = {I}_{1} \times {R}_{1 REF} = {I}_{3} \times {R}_{U} & ( 14 ) \\ {I}_{1} = \frac{( {V}_{R} - {V}_{1} )}{{R}_{1 REF}} & ( 15 )\end{matrix}$$

From Eq. (14):

$${I}_{3} = {I}_{1} \frac{{R}_{1 REF}}{{R}_{U}} \qquad ( 16 )$$

From Eq. (13) and (16):

$${V}_{1} = \frac{{I}_{1} \times ( 1 + \frac{{R}_{1 REF}}{{R}_{U}} ) \times {R}_{D} {R}_{2 REF}}{( {R}_{D} + {R}_{2 REF} )} \\ {V}_{1} = \frac{{I}_{1} \times {R}_{D} \times {R}_{2 REF} ( {R}_{U} + {R}_{1 REF} )}{{R}_{U} \times ( {R}_{D} + {R}_{2 REF} )} \qquad ( 17 )$$

From Eq. (15) and (17):

$$\begin{matrix}{V}_{1} = \frac{\frac{( {V}_{R} - {V}_{1} )}{{R}_{1 REF}} \times {R}_{D} \times {R}_{2 REF} ( {R}_{U} + {R}_{1 REF} )}{{R}_{U} \times ( {R}_{D} + {R}_{2 REF} )} \\ {V}_{1} \times {R}_{U} {R}_{1 REF} \times ( {R}_{D} + {R}_{2 REF} ) = ( {V}_{R} - {V}_{1} ) \times {R}_{D} \times {R}_{2 REF} \times ( {R}_{U} + {R}_{1 REF} ) \\ {V}_{1} \times {R}_{U} \times {R}_{1 REF} \times ( {R}_{D} + {R}_{2 REF} ) + {V}_{1} \times {R}_{D} \times {R}_{2 REF} \times ( {R}_{U} + {R}_{1 REF} ) = {V}_{R} \times {R}_{D} \times {R}_{2 REF} \times ( {R}_{U} + {R}_{1 REF} ) \\ {V}_{1} [ {R}_{U} \times {R}_{1 REF} \times ( {R}_{D} + {R}_{2 REF} ) + {R}_{D} \times {R}_{2 REF} \times ( {R}_{U} + {R}_{1 REF} ) ] = {V}_{R} \times {R}_{D} \times {R}_{2 REF} \times ( {R}_{U} + {R}_{1 REF} ) \\ {V}_{1} = \frac{{V}_{R} \times {R}_{D} \times {R}_{2 REF} \times ( {R}_{U} + {R}_{1 REF} )}{{R}_{U} \times {R}_{1 REF} \times ( {R}_{D} + {R}_{2 REF} ) + {R}_{D} \times {R}_{2 REF} \times ( {R}_{U} + {R}_{1 REF} )} & ( 18 ) \\ Δ V = {V}_{1} - {V}_{2} & ( 19 )\end{matrix}$$

From Eq. (12), (18), and (19):

$$\begin{matrix}Δ V = \frac{{V}_{R} \times {R}_{D} \times {R}_{2 REF} \times ( {R}_{U} + {R}_{1 REF} )}{{R}_{U} \times {R}_{1 REF} \times ( {R}_{D} + {R}_{2 REF} ) + {R}_{D} \times {R}_{2 REF} \times ( {R}_{U} + {R}_{1 REF} )} - \frac{{V}_{R} \times {R}_{4}}{( {R}_{3} + {R}_{4} )} \\ Δ V = [ \begin{matrix}\frac{{R}_{D} \times {R}_{2 REF} \times ( {R}_{U} + {R}_{1 REF} )}{\begin{matrix}{R}_{U} \times {R}_{1 REF} \times ( {R}_{D} + {R}_{2 REF} ) + \\ {R}_{D} \times {R}_{2 REF} \times ( {R}_{U} + {R}_{1 REF} )\end{matrix}} - \\ \frac{{R}_{4}}{( {R}_{3} + {R}_{4} )}\end{matrix} ] & ( 20 ) \\ If {R}_{1 REF} = {R}_{2 REF} and {R}_{3} = {R}_{4} , Then & \\ Δ V = {V}_{R} \times [ \frac{{R}_{D} \times ( {R}_{U} + {R}_{1 REF} )}{{R}_{U} \times ( {R}_{D} + {R}_{1 REF} ) + {R}_{D} \times ( {R}_{U} + {R}_{1 REF} )} - 0.5 ] & ( 21 )\end{matrix}$$

FIG. 4:
V=I₁×(R₁+R_{REF}) (1)
V_{R}=I₁R_{REF} (2)
Divide Eq. (1) by Eq. (2):

$$\begin{matrix}\frac{V}{{V}_{R}} = \frac{( {R}_{1} + {R}_{REF} )}{{R}_{REF}} = \frac{{R}_{1}}{{R}_{REF}} + 1 \\ \frac{{R}_{1}}{{R}_{REF}} = \frac{( V - {V}_{R} )}{{V}_{R}} = \frac{\frac{V}{{I}_{3}} - \frac{{V}_{R}}{{I}_{3}}}{\frac{{V}_{R}}{{I}_{3}}} & ( 3 ) \\ V = {I}_{2} \times ( {R}_{2} + {R}_{U} ) & ( 4 ) \\ V = {I}_{3} \times ( {R}_{3} + {R}_{D} ) & ( 5 )\end{matrix}$$

From Eq. (4) and (5):

$$\begin{matrix}{I}_{2} \times ( {R}_{2} + {R}_{U} ) = {I}_{3} \times ( {R}_{3} + {R}_{D} ) \\ \frac{{I}_{2}}{{I}_{3}} = \frac{( {R}_{3} + {R}_{D} )}{{R}_{2} + {R}_{U}} & ( 6 ) \\ {V}_{1} = {I}_{2} \times {R}_{U} & ( 7 ) \\ {V}_{2} = {I}_{3} \times {R}_{D} & ( 8 ) \\ {V}_{2} - {V}_{R} = \frac{{R}_{5} \times ( {V}_{2} - {V}_{1} )}{( {R}_{4} + {R}_{5} )} & ( 9 )\end{matrix}$$

From Eq. (7), (8), and (9):

$${V}_{R} = {I}_{3} ⨯ {R}_{D} - \frac{{R}_{5} \times ( {I}_{3} \times {R}_{D} - {I}_{2} \times {R}_{U} )}{( {R}_{4} + {R}_{5} )} \\ {V}_{R} = \frac{{I}_{3} \times {R}_{D} \times ( {R}_{4} + {R}_{5} ) - {R}_{5} \times ( {I}_{3} \times {R}_{D} - {I}_{2} \times {R}_{U} )}{( {R}_{4} + {R}_{5} )} \\ {V}_{R} = \frac{{I}_{3} \times {R}_{D} \times {R}_{4} + {I}_{3} \times {R}_{5} - {R}_{5} \times {I}_{3} \times {R}_{D} + {R}_{5} \times {I}_{2} \times {R}_{U}}{( {R}_{4} + {R}_{5} )} \\ \frac{{V}_{R}}{{I}_{3}} = \frac{( {R}_{4} \times {R}_{D} + \frac{{I}_{2} \times {R}_{5} \times {R}_{U} }{{I}_{3}} )}{( {R}_{4} + {R}_{5} )} \qquad ( 10 )$$

From Eq. (6) and (10):

$$\frac{{V}_{R}}{{I}_{3}} = \frac{[ {R}_{4} \times {R}_{D} + \frac{{R}_{5} \times {R}_{U} ( {R}_{3} + {R}_{D} )}{( {R}_{2} + {R}_{U} )} ]}{( {R}_{4} + {R}_{5} )} \\ \frac{{V}_{R}}{{I}_{3}} = \frac{[ {R}_{4} \times {R}_{D} \times ( {R}_{2} + {R}_{U} ) + {R}_{5} \times {R}_{U} ( {R}_{3} + {R}_{D} ) ]}{( {R}_{4} + {R}_{5} ) ( {R}_{2} + {R}_{U} )} \qquad ( 11 )$$

From Eq. (5):

$$\frac{V}{{I}_{3}} = ( {R}_{3} + {R}_{D} ) \qquad ( 12 )$$

From Eq. (3), (11), and (12):

$$\begin{matrix}\frac{{R}_{1}}{{R}_{REF}} = \frac{( \frac{V}{{I}_{3}} - \frac{{V}_{R}}{{I}_{3}} )}{\frac{{V}_{R}}{{I}_{3}}} \\ = \frac{[ ( {R}_{3} + {R}_{D} ) - \frac{[ {R}_{4} \times {R}_{D} \times ( {R}_{2} + {R}_{U} ) + {R}_{5} \times {R}_{U} \times ( {R}_{3} + {R}_{D} ) ]}{( {R}_{4} + {R}_{5} ) ( {R}_{2} + {R}_{U} )} ]}{\frac{[ {R}_{4} \times {R}_{D} \times ( {R}_{2} + {R}_{U} ) + {R}_{5} \times {R}_{U} \times ( {R}_{3} + {R}_{D} ) ]}{( {R}_{4} + {R}_{5} ) ( {R}_{2} + {R}_{U} )}} \\ = \frac{[ \begin{matrix}( {R}_{3} + {R}_{D} ) ( {R}_{4} + {R}_{5} ) ( {R}_{2} + {R}_{U} ) - {R}_{4} \times {R}_{D} \times \\ ( {R}_{2} + {R}_{U} ) - {R}_{5} \times {R}_{U} \times ( {R}_{3} + {R}_{D} )\end{matrix} ]}{{R}_{4} \times {R}_{D} \times ( {R}_{2} + {R}_{U} ) + {R}_{5} \times {R}_{U} \times ( {R}_{3} + {R}_{D} )} \\ = K ( Constant )\end{matrix} \qquad ( 13 )$$

Subtracting Eq. (7) from Eq. (8):

$${V}_{2} - {V}_{1} = {I}_{3} \times {R}_{D} - {I}_{2} \times {R}_{U} = {I}_{3} \times ( {R}_{D} - \frac{{I}_{2} \times {R}_{U}}{{I}_{3}} ) \qquad ( 14 )$$

From Eq. (5), (6), and (14):

$$\begin{matrix}Δ V = \frac{V}{( {R}_{3} - {R}_{D} )} \times [ {R}_{D} - \frac{{R}_{U} \times ( {R}_{3} + {R}_{D} )}{( {R}_{2} + {R}_{U} )} ] \\ Δ V = \frac{V}{( {R}_{3} + {R}_{D} )} \times [ \frac{{R}_{D} \times ( {R}_{2} + {R}_{U} ) - {R}_{U} \times ( {R}_{3} + {R}_{D} )}{( {R}_{2} + {R}_{U} )} ] \\ Δ V = \frac{V}{( {R}_{3} + {R}_{D} )} \times [ \frac{{R}_{D} \times {R}_{2} + {R}_{D} \times {R}_{U} - {R}_{U} \times {R}_{3} - {R}_{U} \times {R}_{D}}{( {R}_{2} + {R}_{U} )} ] \\ Δ V = \frac{V}{( {R}_{3} + {R}_{D} )} \times [ \frac{{R}_{D} \times {R}_{2} - {R}_{U} \times {R}_{3}}{( {R}_{2} + {R}_{U} )} ] \\ Since {R}_{2} = {R}_{3} , \\ Δ V = \frac{V}{( {R}_{2} + {R}_{D} )} \times [ \frac{{R}_{D} \times {R}_{2} - {R}_{U} \times {R}_{2}}{( {R}_{2} + {R}_{U} )} ] \\ Δ V = \frac{V \times {R}_{2} \times ( {R}_{D} - {R}_{U} )}{( {R}_{2} + {R}_{D} ) ( {R}_{2} + {R}_{U} )} & ( 15 ) \\ Divide Eq . ( 1 ) by Eq . ( 2 ) \text{:} \\ \frac{V}{{V}_{R}} = \frac{( {R}_{1} + {R}_{REF} )}{{R}_{REF}} \\ V = {V}_{R} \times \frac{( {R}_{1} + {R}_{REF} )}{{R}_{REF}} & ( 16 )\end{matrix}$$

From Eq. (15) by Eq. (16):

$$Δ V = \frac{{V}_{R} \times {R}_{2} ( {R}_{1} + {R}_{REF} ) \times ( {R}_{D} - {R}_{U} )}{{R}_{REF} \times ( {R}_{2} + {R}_{D} ) ( {R}_{2} + {R}_{U} )} \qquad ( 17 )$$

FIG. 5:
V=I₁×(R_{REF}+R₁) (1)
V_{R}=I₁×R₁ (2)
Divide Eq. (1) by Eq. (2):

$$\begin{matrix}\frac{V}{{V}_{R}} = \frac{( {R}_{REF} + {R}_{1} )}{{R}_{1}} = \frac{{R}_{REF}}{{R}_{1}} + 1 \\ \frac{{R}_{REF}}{{R}_{1}} = \frac{( V - {V}_{R} )}{{V}_{R}} & ( 3 ) \\ V = {I}_{2} \times ( {R}_{U} + {R}_{2} ) & ( 4 ) \\ {V}_{R} = {I}_{2} \times {R}_{2} & ( 5 ) \\ {V}_{R} = {I}_{3} \times {R}_{3} & ( 6 )\end{matrix}$$

From Eq. (5) and (6):

$$\frac{{I}_{3}}{{I}_{2}} = \frac{{R}_{2}}{{R}_{3}} \qquad ( 7 )$$

From Eq. (3), (4), and (5):

$$\begin{matrix}\frac{{R}_{REF}}{{R}_{1}} = \frac{{I}_{2} \times ( {R}_{U} + {R}_{2} ) - {I}_{2} \times {R}_{2}}{{I}_{2} \times {R}_{2}} \\ \frac{{R}_{REF}}{{R}_{1}} = \frac{{I}_{2} \times {R}_{U} + {I}_{2} \times {R}_{2} - {I}_{2} \times {R}_{2}}{{I}_{2} \times {R}_{2}} = \frac{{R}_{U}}{{R}_{2}} \\ \frac{{R}_{1}}{{R}_{REF}} = \frac{{R}_{2}}{{R}_{U}} = K ( Constant ) & ( 8 ) \\ Δ V = {V}_{1} - V & ( 9 ) \\ {V}_{1} = {I}_{3} \times ( {R}_{D} + {R}_{3} ) & ( 10 ) \\ V = {I}_{2} \times ( {R}_{U} + {R}_{2} ) & ( 11 ) \\ {V}_{R} = {I}_{1} \times {R}_{1} = {I}_{2} \times {R}_{2} = {I}_{3} \times {R}_{3} & ( 12 )\end{matrix}$$

From Eq. (9), (10), and (11):
ΔV=I₃×(R_{D}+R₃)−I₂×(R_{U}+R₂) (13)
From Eq. (12) and (13):

$$Δ v = \frac{{V}_{R}}{{R}_{3}} \times ( {R}_{D} + {R}_{3} ) - \frac{{V}_{R}}{{R}_{2}} \times ( {R}_{U} + {R}_{2} )$$

Since R₂=R₃,

$$Δ V = \frac{{V}_{R}}{{R}_{2}} \times ( {R}_{D} + {R}_{2} - {R}_{U} - {R}_{2} ) \\ Δ V = \frac{{V}_{R}}{{R}_{2}} \times ( {R}_{D} - {R}_{U} ) \qquad ( 14 )$$

FIG. 6:
V=I₁×(R_{REF}+R₁) (1)
V_{R}=I₁×R_{REF} (2)
Divide Eq. (1) by Eq. (2):

$$\begin{matrix}\frac{V}{{V}_{R}} = \frac{( {R}_{REF} + {R}_{1} )}{{R}_{REF}} = \frac{{R}_{1}}{{R}_{REF}} + 1 \\ \frac{{R}_{1}}{{R}_{REF}} = \frac{( V - {V}_{R} )}{{V}_{R}} & ( 3 ) \\ V = {I}_{2} \times ( {R}_{U} + {R}_{2} ) & ( 4 ) \\ {V}_{R} = {I}_{2} \times {R}_{U} & ( 5 )\end{matrix}$$

From Eq. (3), (4), and (5):

$$\begin{matrix}\frac{{R}_{1}}{{R}_{REF}} = \frac{[ {I}_{2} \times ( {R}_{U} + {R}_{2} ) - {I}_{2} \times {R}_{U} ]}{( {I}_{2} \times {R}_{U} )} \\ \frac{{R}_{1}}{{R}_{REF}} = \frac{[ {I}_{2} \times {R}_{2} ]}{( {I}_{2} \times {R}_{U} )} = \frac{{R}_{2}}{{R}_{U}} = K ( Constant ) & ( 6 ) \\ Δ V = V - {V}_{1} & ( 7 ) \\ {V}_{1} = {I}_{3} \times ( {R}_{D} + {R}_{3} ) & ( 8 ) \\ V = {I}_{2} \times ( {R}_{U} + {R}_{2} ) & ( 9 ) \\ {V}_{R} = {I}_{1} \times {R}_{REF} = {I}_{2} \times {R}_{U} = {I}_{3} \times {R}_{D} & ( 10 )\end{matrix}$$

From Eq. (7), (8), and (9):

$$Δ V = {I}_{2} ⨯ ( {R}_{U} + {R}_{2} ) - {I}_{3} ⨯ ( {R}_{D} + {R}_{3} ) \\ Δ V = {I}_{3} [ \frac{{I}_{2}}{{I}_{3}} ⨯ ( {R}_{U} + {R}_{2} ) - ( {R}_{D} + {R}_{3} ) ] \qquad ( 11 )$$

From Eq. (10) and (11):

$$\begin{matrix}Δ V = {I}_{3} [ \frac{{R}_{D}}{{R}_{U}} \times ( {R}_{U} + {R}_{2} ) - ( {R}_{D} + {R}_{3} ) ] & \\ Δ V = \frac{{I}_{3}}{{R}_{U}} \times [ {R}_{D} \times {R}_{U} + {R}_{D} \times {R}_{2} - {R}_{D} \times {R}_{U} - {R}_{U} \times {R}_{3} ] \\ S ince {R}_{2} = {R}_{3} , & \\ Δ V = \frac{{I}_{3} \times {R}_{2}}{{R}_{U}} \times [ {R}_{D} - {R}_{U} ] & ( 12 )\end{matrix}$$

From Eq. (10) and (12):

$$Δ V = \frac{{V}_{R} \times {R}_{2}}{{R}_{U} \times {R}_{D}} \times [ {R}_{D} - {R}_{U} ] \qquad ( 13 )$$

What is claimed is:

1. A method of operating a fluid flow measurement sensor having an upstream element and a downstream element, the method comprising:
measuring ambient temperature of a fluid entering the sensor; and
maintaining the upstream element, or the downstream element, or a combination of the upstream and downstream elements at a constant temperature differential with respect to the ambient temperature of the fluid.

2. The method of claim 1, wherein the upstream and downstream elements each comprises a coil or a planar heating element.

3. The method of claim 1, wherein the maintaining comprises changing the temperature of the upstream element, or downstream element, or both the upstream and downstream elements.

4. The method of claim 1, wherein the maintaining comprises changing the voltage across the upstream and downstream element in proportion to the flow of fluid through the sensor.

5. The method of claim 1, wherein ambient resistances of the upstream and downstream elements are approximately the same.

6. The method of claim 1, wherein the voltage across the upstream and downstream element is approximately equal when no fluid flows through the sensor.

7. The method of claim 1, wherein the maintaining comprises changing a resistance of the upstream element, or downstream element, or both the upstream and downstream elements in proportion to an amount of heat loss in the upstream element, downstream element, or both the upstream and downstream elements.

8. The method of claim 1, further comprising limiting current through the upstream and downstream elements.

9. A fluid flow measurement sensor circuit comprising:
an amplifier;
first and second resistive elements in parallel coupled to an output lead of the amplifier;
a third resistive element in series with the first resistive element, wherein the third resistive element is coupled to ground;
fourth and fifth resistive elements in series with the second resistive element, wherein the fifth resistive element is coupled to ground; and
sixth and seventh resistive elements in series, wherein the sixth and seventh resistive elements are in parallel with the fourth and fifth resistive elements, the sixth resistive element coupled between the second and fourth resistive elements, and the seventh resistive element coupled to ground, wherein the output signal of the circuit is measured between the fourth and fifth resistive elements and the sixth and seventh resistive elements.

10. The sensor circuit of claim 9, wherein the resistance of the sixth and seventh resistive elements are approximately equal and resistance of the fourth and fifth resistive elements are approximately equal.

11. The sensor circuit of claim 9, wherein the resistance of the second resistive element is within approximately 50% of the resistance of the fourth and fifth resistive elements.

12. The sensor circuit of claim 9, further comprising a current limiting circuit between the output lead of the amplifier and the first and second resistive elements.

13. The sensor circuit of claim 9, wherein the third, fourth, and fifth resistive elements all comprise the same material.

14. The sensor circuit of claim 9, further comprising an eighth resistive element coupled in series between the third resistive element and ground.

15. The sensor circuit of claim 14, wherein the resistance of the third and eighth resistive elements are approximately equal.

16. The sensor circuit of claim 14, wherein the third, fourth, fifth, and eighth resistive elements all comprise the same material.

17. A fluid flow measurement sensor circuit comprising:
an amplifier;
first and second resistive elements in series, wherein the first resistive element is coupled to an output lead of the amplifier and the second resistive element is coupled to ground;
third and fourth resistive elements in series, wherein the third resistive element is coupled to the output lead of the amplifier and the fourth resistive element is coupled to ground;
fifth and sixth resistive elements in series, wherein the fifth resistive element is coupled to the output lead of the amplifier and the sixth resistive element is coupled to ground; and
seventh and eighth resistive elements in series, wherein one end of the seventh resistive element is coupled to the node of the third and fourth restive elements and one end of the eighth resistive element is coupled to the node of the fifth and sixth restive elements, wherein the output signal of the circuit is measured between the third and fourth resistive elements and the fifth and sixth resistive elements.

18. The sensor circuit of claim 17, wherein the resistance of the fourth and sixth resistive elements are approximately equal.

19. The sensor circuit of claim 17, further comprising a current limiting circuit between the output lead of the amplifier and the first, third, and fifth resistive elements.

20. The sensor circuit of claim 17, wherein the resistance of the third and fifth resistive elements is approximately equal and is within approximately 50% of the resistance of the fourth and sixth resistive elements.

21. The sensor circuit of claim 17, wherein the second, fourth, and sixth resistive elements all comprise the same material.

22. A fluid flow measurement sensor circuit comprising:
a first amplifier;
first and second resistive elements in series, wherein the first resistive element is coupled to an output lead of the first amplifier and the second resistive element is coupled to ground;
third and fourth resistive elements in series, wherein the third resistive element is coupled to the output lead of the amplifier and the fourth resistive element is coupled to ground;
a second amplifier; and
fifth and sixth resistive elements in series, wherein the fifth resistive element is coupled to the output lead of the second amplifier and the sixth resistive element is coupled to ground, wherein the output signal of the circuit is measured between the output lead of the first amplifier and the first and third resistive elements and the output lead of the second amplifier and the fifth resistive element.

23. The sensor circuit of claim 22, wherein the resistance of the third and fifth resistive elements are approximately equal.

24. The sensor circuit of claim 22, further comprising a current limiting circuit between the output lead of the first amplifier and the first and third resistive elements.

25. The sensor circuit of claim 22, wherein the first, third, and fifth resistive elements all comprise the same material.

26. The sensor circuit of claim 22, wherein the resistance of the fourth and sixth resistive elements are approximately equal.

27. The sensor circuit of claim 22, wherein the second, fourth, and sixth resistive elements all comprise the same material.
